(19) United States
(12) Patent Application Publication
(10) Pub. No.: US 2023/0321688 A1
(43) Pub. Date: Oct. 12, 2023

(54) METHOD OF PRODUCING MAGNESIUM-CONTAINING COMPONENTS HAVING VISUAL METALLIC SURFACES

(71) Applicant: Magnesium Products of America Inc., Eaton Rapids, MI (US)

(72) Inventors: Jonathan Patrick Weiler, London (CA); Xu Wang, London (CA)

(73) Assignee: Magnesium Products of America Inc., Eaton Rapids, MI (US)

(21) Appl. No.: 17/718,917

(22) Filed: Apr. 12, 2022

(51) Int. Cl. B05D 5/06; B05D 3/12; B05D 3/06; B05D 7/14; B05D 7/00

(52) U.S. Cl. CPC B05D 5/067; B05D 3/12; B05D 3/06; B05D 7/14; B05D 7/53

(57) ABSTRACT

A method of coating magnesium includes applying a surface finish to a magnesium substrate to obtain a surface-finished magnesium substrate having a visual profile. The method includes pretreating the surface-finished magnesium substrate to obtain a pretreated magnesium substrate. The method includes depositing a clear powder coat onto the pretreated magnesium substrate to obtain a powder-coated magnesium substrate. The powder-coated magnesium substrate retains the visual profile of the surface-finished magnesium substrate or as-cast magnesium.

### BACKGROUND

Magnesium alloys have utility in a wide variety of applications, including, for example, automotive applications (e.g., vehicle panels, structural members, and the like). One highly advantageous feature of using magnesium alloys in automotive applications is that such alloys provide high strength and good formability, and additionally can result in significant weight savings as compared to more traditional steel components.

In certain vehicle applications, it may be desirable for aesthetic or other reasons to have a passenger-facing surface within a vehicle cabin (a so-called “Class A” surface) that has a metallic appearance. Because metallic components are ordinarily not provided as naked metal surfaces so to avoid negative effects such as oxidation, a surface treatment or coating may ordinarily be applied to the metallic component. For example, where magnesium alloys are used for the metallic components forming the Class A surface, one approach has involved applying a powder coat to a magnesium substrate to approximate a metallic appearance. One disadvantage of this powder coating process, however, is that the underlying magnesium substrate is no longer visible once the powder coat has been applied to the magnesium substrate. In other scenarios, a pretreatment may be applied to the magnesium substrate, which can disadvantageously result in discoloration of the appearance of the magnesium substrate.

It would be advantageous to provide a method for treating magnesium substrates to allow such substrates to retain their metallic visual appearance while addressing the challenges associated with having a metal surface exposed as a Class A visual surface. A surface finish could be applied to the magnesium substrate such that the appearance of the surface-finished magnesium substrate would be visible after undergoing processing steps to achieve advantageous properties (e.g., mechanical properties, corrosion resistance, hardness, wear resistance, and cost). These and other advantageous features will become apparent to those reviewing the present disclosure.

### SUMMARY

Embodiments described herein relate generally to the methods for treating (e.g., coating) a magnesium-containing substrate to provide a visual surface that retains its metallic aesthetic. The coating of the magnesium-containing substrate can be free of undesirable coloration while having sufficient wear resistance to be classified as a Class A coating.

At least one aspect of the present disclosure is directed to a method of coating magnesium. The method includes applying a surface finish to a magnesium substrate to obtain a surface-finished magnesium substrate having a visual profile. The method includes pretreating the surface-finished magnesium substrate with a BASF Oxsilan 9831 process to obtain a pretreated magnesium substrate. The method includes depositing a clear powder coat onto the pretreated magnesium substrate to obtain a powder-coated magnesium substrate. The powder-coated magnesium substrate retains the visual profile of the surface-finished magnesium substrate.

Another aspect of the present disclosure is directed to a method of coating magnesium. The method includes applying a surface finish to a magnesium substrate to obtain a surface-finished magnesium substrate having a visual profile. The method includes pretreating the magnesium substrate with a Henkel MgC process to obtain a pretreated magnesium substrate. The method includes depositing a clear powder coat onto the pretreated magnesium substrate to obtain a powder-coated magnesium substrate. The powder-coated magnesium substrate retains the visual profile of the surface-finished magnesium substrate.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a vehicle cabin with one or more exposed magnesium Class A surface components, in accordance with some embodiments.

FIG. 2 illustrates an as-cast magnesium substrate in accordance with some embodiments and a pretreated magnesium substrate using conventional or existing processes.

FIG. 3 illustrates the as-cast magnesium substrate and sanding panels of magnesium substrates, in accordance with some embodiments.

FIG. 4 illustrates grinding panels of magnesium substrates, in accordance with some embodiments.

FIG. 5 illustrates laser etching finishes of magnesium substrates, in accordance with some embodiments.

FIG. 6 illustrates sanded and ground magnesium substrates that have undergone a BASF Oxsilan 9831 process, in accordance with some embodiments.

FIG. 7 illustrates the pretreated magnesium substrates of FIG. 6 that have undergone a powder coating process, in accordance with some embodiments.

FIG. 8 illustrates sanded and ground magnesium substrates that have undergone a Henkel MgC process, in accordance with some embodiments.

FIG. 9 illustrates the pretreated magnesium substrates of FIG. 8 that have undergone a powder coating process, in accordance with some embodiments.

FIG. 10 illustrates a method of coating magnesium, in accordance with some embodiments.

FIG. 11 illustrates a plot of surface roughness vs. powder coat gloss level of magnesium substrates, in accordance with some embodiments.

Like reference numbers and designations in the various drawings indicate like elements.

### DETAILED DESCRIPTION

Following below are more detailed descriptions of various concepts related to, and implementations of, methods, apparatuses, and systems for coating magnesium, magnesium alloys, or magnesium-containing substrates to provide a visual surface that retains its metallic aesthetic. The various concepts introduced above and discussed in greater detail below may be implemented in any of a number of ways, as the described concepts are not limited to any particular manner of implementation. Examples of specific implementations and applications are provided primarily for illustrative purposes.

The present disclosure is directed to methods for treating a magnesium substrate (e.g., magnesium-containing substrate) or alloy to provide a visual surface that retains its metallic aesthetic. Existing treatment processes for magnesium-containing substrates can have a number of issues, including, but not limited to, discoloration of the magnesium-containing substrate, concealment of the underlying metallic character of the magnesium-containing substrate, and insufficient wear resistance. Additionally, existing coating processes for magnesium-containing substrates can be susceptible to corrosion. Pores located in or on the coating of the magnesium-containing substrate can increase the risk of corrosion. Existing coating processes for other alloys, such as aluminum alloys or steel, may not be effective or practical for magnesium alloys. For example, coating processes for aluminum can include applying a coating containing acid (e.g., sulfuric acid, nitric acid, phosphoric acid, etc.) which would rapidly dissolve magnesium alloys rather than forming a protective layer. While existing processes can be applied to aluminum alloys containing magnesium, these aluminum alloys typically contain a small amount of magnesium (e.g., less than 3 wt %). In contrast, magnesium alloys can contain greater than 80 wt % or 90 wt % magnesium.

The methods of the present disclosure can address these and other problems associated with treating a magnesium-containing substrate to provide a visual surface that retains its metallic aesthetic while the coating of the magnesium-containing substrate achieves a sufficient wear resistance to be classed as a Class A coating. Additionally, the pretreatment process and the powder coating process can provide a clear coating layer with a thickness of about 50-200 μm. This clear coating layer can be thick enough to provide wear resistance and physical protection of the underlying magnesium-containing substrate.

According to an exemplary embodiment, methods are provided for coating magnesium, a magnesium alloy, or a magnesium substrate (e.g., magnesium-containing substrate). The surface of the magnesium, magnesium alloy, or magnesium substrate can have the appearance of raw magnesium or magnesium metal. The method can provide a visible surface without changing the color of the underlying magnesium, magnesium alloy, or magnesium substrate (e.g., as-cast magnesium substrate, as-cast magnesium alloy, etc.). The methods of the present disclosure can overcome the limitations of existing production processes which can result in a discoloration (e.g., yellowing or greening) of the magnesium or which do not simulate the as-cast magnesium with sufficient detail. For example, existing production processes may only be able to simulate 10% of the as-cast magnesium, while the methods of the present disclosure can simulate a higher percentage of the as-cast magnesium such as 95% of the as-cast magnesium.

According to a particular exemplary embodiment, the method includes applying a surface finish to a magnesium substrate to obtain a surface-finished magnesium substrate having a visual profile, pretreating the surface-finished magnesium substrate with a BASF Oxsilan 9831 process to obtain a pretreated magnesium substrate, and depositing a clear powder coat onto the pretreated magnesium substrate to obtain a powder-coated magnesium substrate. The powder-coated magnesium substrate retains the visual profile of the surface-finished magnesium substrate or the as-cast magnesium substrate.

According to a particular exemplary embodiment, the method includes applying a surface finish to a magnesium substrate to obtain a surface-finished magnesium substrate having a visual profile, pretreating the surface-finished magnesium substrate with a Henkel MgC process to obtain a pretreated magnesium substrate, and depositing a clear powder coat onto the pretreated magnesium substrate to obtain a powder-coated magnesium substrate. The powder-coated magnesium substrate retains the visual profile of the surface-finished magnesium substrate or the as-cast magnesium substrate.

The methods of the present disclosure can allow for a clear coating system that includes surface preparation (e.g., sanding, orbital sanding, grinding, belt sanding, wire brushing, etc.), pretreatment, and powder coating. The surface preparation can be used to create different textures resulting in different visual surfaces. The methods can provide a Class A coating for magnesium alloys and magnesium substrates. The coating can be transparent and reveal (e.g., show) the underlying magnesium alloy or substrate. The coating can reveal the metallic appearance of the underlying magnesium alloy or substrate as opposed to providing a non-transparent metallic surface finish. For example, instead of being a shiny metal coating deposited onto the magnesium alloy or substrate, the coating can be clear and/or transparent.

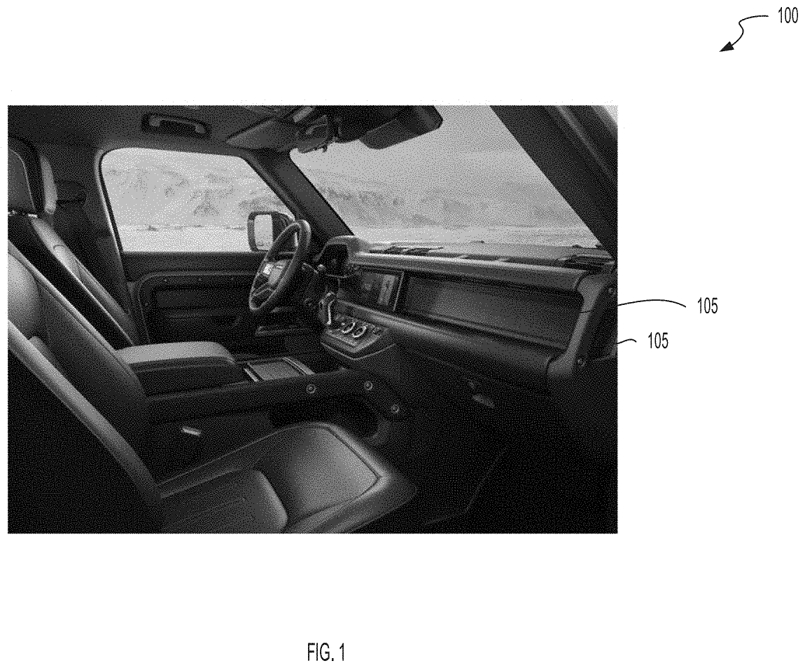

FIG. 1 illustrates a vehicle cabin 100 with one or more components formed from magnesium or magnesium alloys and having a metallic aesthetic appearance (hereinafter referred to in the interest of brevity as “exposed magnesium” components). The exposed magnesium components can include, for example, one or more magnesium panels 105. The one or more magnesium panels 105 can include magnesium substrates that have undergone a finishing process (e.g., treatment process, surface treatment process, coating process, surface coating process, etc.). For example, the finishing process can treat the magnesium substrate such that the magnesium substrate meets performance and aesthetic standards for interior metallic components. For example, the exposed magnesium components or magnesium substrates can have desirable chemical resistance, corrosion, and adhesion properties.

The surface finish (e.g., coating, surface coating, etc.) on the magnesium substrate can advantageously meet the General Motors Worldwide Engineering Standards Material Specification Finish GMW14669, which provides for organic coating performance for exterior and interior metallic materials. The surface finish on the magnesium substrate can be classified as Type B1 according to the GMW14669 specification. The Type B1 classification is applicable to surface finishes used on internal body parts and components in areas of severe service operations (e.g., solar, direct sunlight exposure, and corrosion, items in contact with a wet floor, such as a lower seat structure).

The surface finish on the magnesium substrate can have a 0 or 1 rating according to the adhesion requirement in General Motors Worldwide Engineering Standards Test Procedure GMW14829 (tape adhesion test for paint finishes). The surface finish on the magnesium substrate can have a 0 or 1 rating with a duration of 144 hours according to the adhesion after humidity requirement in the GMW14729 specification (tape adhesion test for paint finishes). The surface finish on the magnesium substrate can have no surface change with a duration of 144 hours according to the humidity exposure test requirement in the GMW14729 specification (procedures for high humidity test). The surface finish on the magnesium substrate can have a rating of 10 and 3 mm of creep with interior (INT), mounting location of mid/high, and a duration of 7 cycles/12 cycles according to the cyclic corrosion testing requirement in the General Motors Worldwide specification GMW14872 (cyclic corrosion). The surface finish on the magnesium substrate can have a hardness of minimum “H” according to the pencil hardness test requirement in specification ISO15184 (Paints and Varnishes—Determination of Film Hardness by Pencil Test). The surface finish on the magnesium substrate can have a rating of 0 or 1 according to the cure test requirement in General Motors Worldwide specification GMW15891 (solvent rub method for determining cure of painted metal or plastic substrates introduction). The surface finish on the magnesium substrate can have a rating of 2 according to the cleaning agent resistance requirement with Code A in General Motors Worldwide specification GMW14334 (chemical resistance to fluids). The surface finish on the magnesium substrate can have no wear through with a CS10 wheel, 500 g load, and 1000 cycles according to the wear resistance requirement in General Motors Worldwide specification GMW3208 (rotary abrasion test).

Advantageously, the magnesium panels 105 can have visual profiles (e.g., desired visual profiles) with the appearance of raw magnesium. For example, the magnesium panels 105 can have the appearance of magnesium metal, raw magnesium, or as-cast magnesium. According to an exemplary embodiment, the magnesium panels 105 are formed of a magnesium alloy (e.g., magnesium alloy AM60B, magnesium alloy AM50A, or magnesium alloy AZ91D), and may be used in a variety of vehicle applications (e.g., as a backing for a vehicle infotainment center, as a cover for a vehicle infotainment center, as decorative elements, or for any other desired purpose).

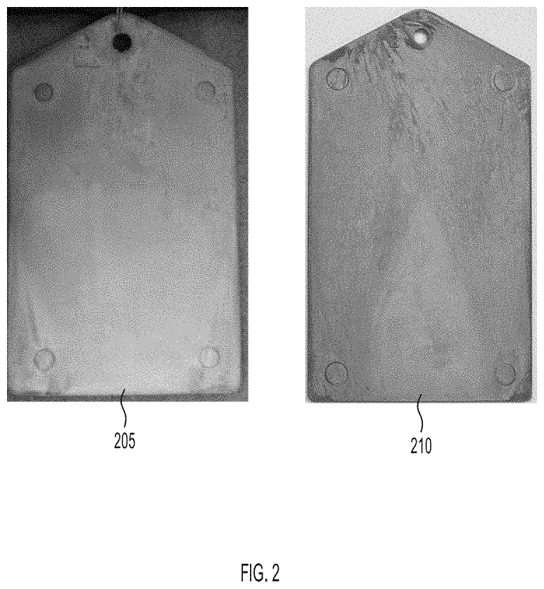

FIG. 2 illustrates an as-cast magnesium substrate 205 and a pretreated magnesium substrate 210. The as-cast magnesium substrate 205 can include a cast magnesium alloy. The as-cast magnesium substrate 205 can be obtained directly from casting (e.g., via melting and solidification). The as-cast magnesium substrate 205 can include a magnesium substrate or magnesium alloy that has not undergoing any further chemical or mechanical processing (e.g., machining, coating, finishing, chemical alteration, etc.) subsequent to the casting process. The magnesium alloy can include mixtures of magnesium with other metals (e.g., aluminum, zinc, manganese, silicon, copper, rare earths, zirconium, etc.). According to an exemplary embodiment, the magnesium alloy can include a percentage of magnesium, for example, 80 wt % magnesium, 81 wt % magnesium, 82 wt % magnesium, 83 wt % magnesium, 84 wt % magnesium, 85 wt % magnesium, 86 wt % magnesium, 87 wt % magnesium, 88 wt % magnesium, 89 wt % magnesium, 90 wt % magnesium, 90.8 wt % magnesium, 91 wt % magnesium, 91.5 wt % magnesium, 92 wt % magnesium, 93 wt % magnesium, 93.5 wt % magnesium, 93.6 wt % magnesium, 94 wt % magnesium, 95 wt % magnesium, 96 wt % magnesium, 97 wt % magnesium, 98 wt % magnesium, 99 wt % magnesium, or 99.2 wt % magnesium, with the remainder being one or more metals. The magnesium alloy can include a cast alloy (e.g., cast magnesium alloy). For example, the magnesium alloy can include AZ63, AZ81, AZ91, AM50, AM60, ZK51, ZK61, ZE41, ZC63, HK31, HZ32, QE22, QH21, WE54, WE43, or Elektron 21.

The as-cast magnesium substrate 205 can have the appearance of raw magnesium (e.g., elemental magnesium, native magnesium, Mg, etc.). For example, the appearance of raw magnesium can include the visual appearance and/or characteristics of elemental magnesium. The as-cast magnesium substrate 205 can show the metallic appearance of the as-cast magnesium substrate 205 rather than from a coating deposited onto the as-cast magnesium substrate 205. The as-cast magnesium substrate 205 can have a metallic aesthetic appearance (e.g., gray appearance, shiny gray appearance, silvery white appearance, gray-white appearance, ceramic-white appearance, or ceramic-gray appearance). The as-cast magnesium substrate 205 can have a luster or shine. The as-cast magnesium substrate 205 can have a shiny appearance as opposed to a dull appearance. For example, the as-cast magnesium substrate 205 can be shiny because it reflects light. The as-cast magnesium substrate 205 can have the appearance of a magnesium ore. For example, the as-cast magnesium substrate 205 can have the appearance of magnesite (MgCO₃), dolomite (CaMg(CO₃)₂), or carnallite (KMgCl₃·6(H₂O)).

The pretreated magnesium substrate 210 can include a magnesium substrate treated using conventional or existing processes. The pretreated magnesium substrate 210 can include the magnesium substrate prior to powder coating the magnesium substrate. An example of these existing processes is the Henkel Alodine® 5200 treatment (e.g., Alodine treatment, Alodine process, chem film treatment, chem film process, etc.). The Alodine treatment can include a non-chromate conversion coating that protects magnesium and other metals (e.g., aluminum) from corrosion. The Alodine treatment can cause coloration or discoloration of the as-cast magnesium substrate 205. For example, the Alodine treatment can include coating the as-cast magnesium substrate 205 with Alodine to obtain the pretreated magnesium substrate 210. The pretreated magnesium substrate 210 can include an as-cast magnesium substrate 205 with an Alodine coating. The Alodine treatment can include coating the as-cast magnesium substrate 205 with Alodine and exposing the Alodine-coated substrate to heat. The Alodine-coated substrate can be exposed to a temperature of greater than 200° C. (e.g., 210° C., 220° C., 230° C., 240° C., 250° C., 260° C., 270° C., 280° C., 290° C., 300° C., 350° C., 400° C., 500° C., etc.). The pretreated magnesium substrate 210 can include the heat-treated Alodine-coated substrate. The as-cast magnesium substrate 205 may need to be exposed to a temperature of greater than 200° C. for degassing prior to the powder coating process.

Existing processes (e.g., Alodine treatment) can result in a discoloration of the as-cast magnesium substrate 205. Organic components in the Alodine can discolor the organic fluoride Zr/Ti-based propoxypropanol conversion coating during the degassing and heating process. These organic components, prior to the degassing and heating process, can be transparent such that the magnesium substrate retains its metallic aesthetic appearance or underlying metallic appearance. While the as-cast magnesium substrate 205 is coated with Alodine, the coated magnesium substrate can have a metallic aesthetic appearance prior to the degassing and heating process. However, after the degassing and heating process, the organic components can become discolored and cause the magnesium substrate to lose its metallic aesthetic appearance. The pretreated magnesium substrate 210 can include the as-cast magnesium substrate 205 after it has been coated with Alodine, degassed, and heated to a temperature of greater than 200° C. The pretreated magnesium substrate 210 can have a yellowish and/or greenish color.

The existing processes can change the appearance of the as-cast magnesium substrate 205 such that the appearance of the pretreated magnesium substrate 210 has a yellowish or greenish color. The appearance of the as-cast magnesium substrate 205 can be different from the appearance of the pretreated magnesium substrate 210. For example, the appearance of the as-cast magnesium substrate 205 can be different from the appearance of a magnesium substrate that have undergone Alodine treatment. The appearance of the as-cast magnesium substrate 205 can be different from the appearance of a magnesium substrate coated with Alodine and heated to a temperature of greater than 200° C. The existing processes can also discolor other metal substrates such as aluminum substrates or steel substrates. Cleaning chemicals such as acetic acid may not discolor the as-cast magnesium substrate 205.

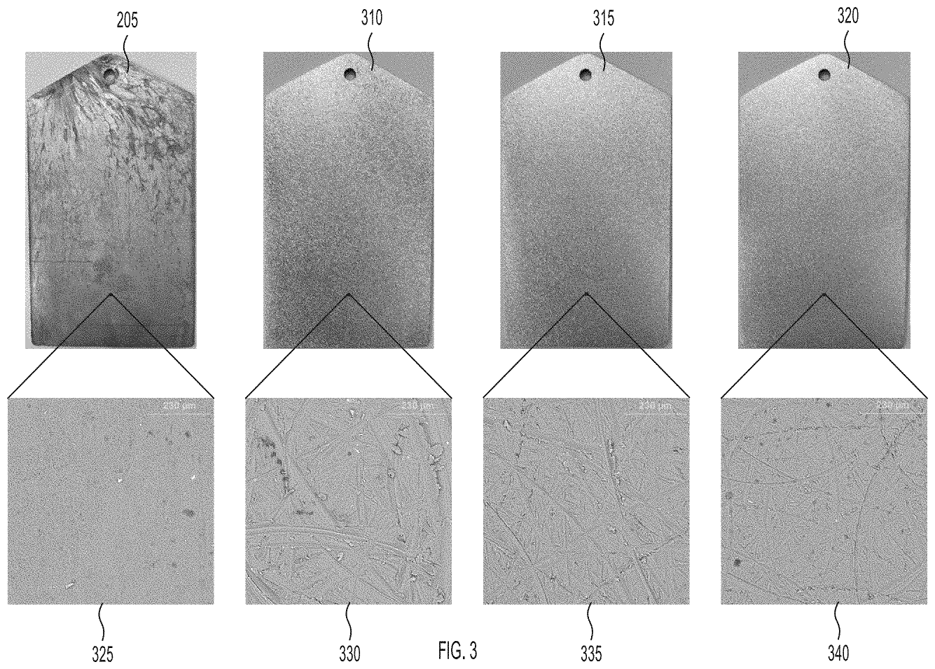

FIG. 3 illustrates the as-cast magnesium substrate 205 as well as three sanding panels of cast magnesium substrates (from left to right, a substrate 310 sanded with 40-grit paper, a substrate 315 sanded with 120-grit paper, and a substrate 320 sanded with 180-grit paper). The lower row provides magnified views of the panels in the top row (i.e., image 325 is an enlarged view (scanning electron microscope (SEM) image) of substrate 205, image 330 is a magnified view (SEM image) of substrate 310, image 335 is a magnified view (SEM image) of substrate 315, and image 340 is a magnified view (SEM image) of substrate 320).

As shown in FIG. 3, the magnified image 325 of the as-cast magnesium substrate 205 illustrates surface inhomogeneities such as deviations from an average height of the surface (e.g., surface height) and/or deviations from the average distance between local maxima of the surface.

The 40-grit, 120-grit, and 180-grit sanding panels of magnesium substrates shown in FIG. 3 illustrate magnesium substrates (e.g., as-cast magnesium substrate 205) that have undergone or been subjected to a surface finishing step (e.g., orbital sanding, orbital buffing, etc.). The resulting magnesium substrates (e.g., magnesium substrates that have undergone or been subjected to the surface finishing step) have various surface textures corresponding to the grit of the sanding (e.g., alumina) paper, with the 180-grit panel having an overall “smoother” surface texture than the 40-grit or 120-grit panels. The sanding process may be performed prior to pretreatment of the magnesium substrate. The resulting magnesium substrates can be referred to as surface-finished magnesium substrates. Typical as-cast magnesium can have a Ra (e.g., arithmetic mean roughness, surface roughness) of 0.9±0.2. As-cast magnesium including a powder coat can have a Ra of 1.23±0.2. A magnesium substrate sanded with 40-grit paper can have a Ra of 1.9±0.4. A magnesium substrate sanded with 120-grit paper can have a Ra of 1.65±0.2. A magnesium substrate sanded with 180-grit paper can have a Ra of 1.35±0.2.

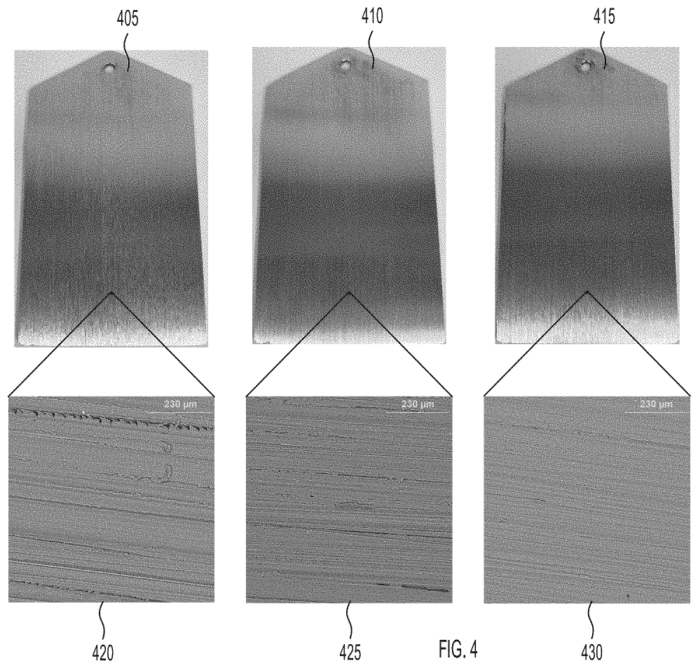

FIG. 4 illustrates grinding panels of magnesium substrates. The grinding panels of magnesium substrates can include magnesium substrates that have undergone or been subjected to a surface finishing step (e.g., belt sanding, wire brushing, etc.). The resulting magnesium substrates (e.g., magnesium substrate that has undergone or been subjected to the surface finishing step) can have various surface textures corresponding to the grit of the sanding belt. The magnesium substrate can undergo a wire brush sanding finish. The wire-brushed (e.g., brushed) magnesium substrate can result in a brushed magnesium substrate. Grinding can be a mechanical finishing step that is performed before or prior to pretreatment of the magnesium substrate. Belt sanding can be a mechanical finishing step that is performed before or prior to pretreatment of the magnesium substrate. Wire brushing can be a mechanical finishing step that is performed before or prior to pretreatment of the magnesium substrate. The resulting magnesium substrates can be referred to as surface-finished magnesium substrates.

The grinding panels of magnesium substrates include, from left to right, a substrate 405 ground with a 40-grit sanding belt, a substrate 410 ground with a 60-grit sanding belt, and a substrate 415 ground with an 80-grit sanding belt. The lower row provides magnified view of the panels in the top row (i.e. image 420 is a magnified view (SEM image) of substrate 405, image 425 is a magnified view (SEM image) of substrate 410, and image 430 is a magnified view (SEM image) of substrate 415). The as-cast magnesium substrate 205 can undergo belt sanding or wire brushing.

The 40-grit, 60-grit, and 80-grit grinding panels of magnesium substrates shown in FIG. 4 illustrate magnesium substrates (e.g., as-cast magnesium substrate 205) that have undergone or been subjected to a surface finishing step (e.g., belt sanding, wire brushing, grinding, etc.). The resulting magnesium substrates (e.g., magnesium substrates that have undergone or been subjected to the surface finishing step) have various surface textures corresponding to the grit of the sanding (e.g., alumina) paper, with the 80-grit panel having an overall “smoother” surface texture than the 40-grit or 60-grit panels. The grinding process may be performed prior to pretreatment of the magnesium substrate. The resulting magnesium substrates can be referred to as surface-finished magnesium substrates. A magnesium substrate ground with 40-grit paper can have a Ra of 3±0.4 measured perpendicular to the grinding. The magnesium substrate ground with 40-grit paper can have a Ra of 1.0±0.15 measured parallel to the grinding. A magnesium substrate ground with 60-grit paper can have a Ra of 1.5±0.2 measured perpendicular to the grinding. The magnesium substrate ground with 60-grit paper can have a Ra of 0.75±0.15 measured parallel to the grinding. A magnesium substrate ground with 80-grit paper can have a Ra of 1.4±0.15 measured perpendicular to the grinding. The magnesium substrate ground with 80-grit paper can have a Ra of 0.5 ±0.15 measured parallel to the grinding.

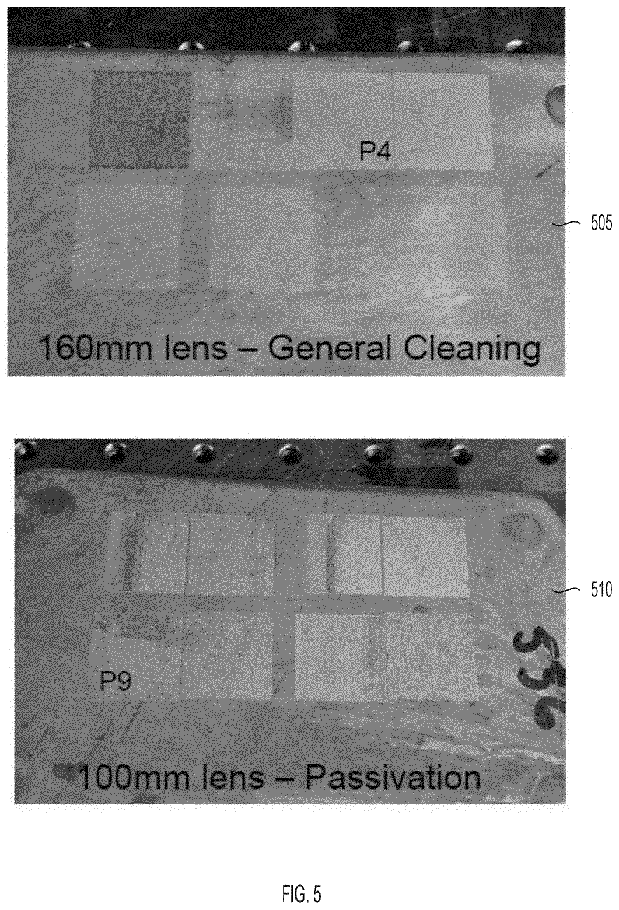

FIG. 5 illustrates laser etching finishes of magnesium substrates. The as-cast magnesium substrate 205 can undergo or be subjected to a surface finishing step that includes laser etching. The laser etching process can result in magnesium substrates with different surface textures. The magnesium substrate can undergo cleaning and etching with different process parameters. The magnesium substrate can include a cleaned magnesium substrate 505. The cleaned magnesium substrate 505 can be etched with a 160 mm lens laser. The magnesium substrate can include a passivated magnesium substrate 510. The passivated magnesium substrate 510 can be etched with a 100 mm lens laser. Laser etching can be a mechanical finishing step that is performed before or prior to pretreatment of the magnesium substrate. The P4 parameter can use a 29.33 cm²/s removal rate and a 160 mm lens. The P4 parameter can result in a magnesium substrate with a Ra of 0.286 microns in 5 seconds. The P9 parameter can use a 17.6 cm²/s removal rate and a 100 m lens. The P9 parameter can result in a magnesium substrate with a Ra of 0.992 microns in 9 seconds.

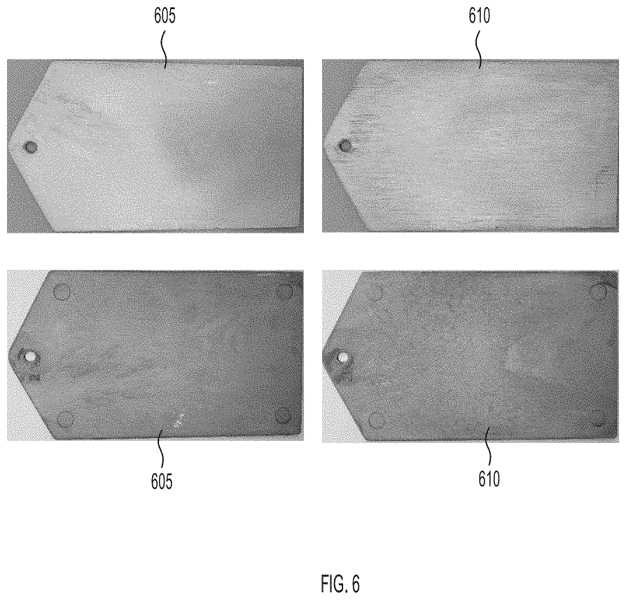

FIG. 6 illustrates sanded and ground magnesium substrates that have undergone a pretreatment process such as the BASF Oxsilan 9831 process (e.g., BASF Oxsilan 9831 treatment process, etc.). A first magnesium substrate 605 can include a magnesium substrate (e.g., AM60B magnesium substrate) that has undergone sanding (e.g., orbital sanding) and the BASF Oxsilan 9831 process. The first magnesium substrate 605 can include a magnesium substrate that has undergone the BASF Oxsilan 9831 process. The BASF Oxsilan 9831 process can occur subsequent to the orbital sanding process. The first magnesium substrate 605 can include, for example, the 40-grit sanded magnesium substrate 310, the 120-grit sanded magnesium substrate 315, the 180-grit sanded magnesium substrate 320, or any other sanded magnesium substrate. The top image of the first magnesium substrate 605 shows a first side of the first magnesium substrate 605. The bottom image of the first magnesium substrate 605 shows a second (e.g., opposite) side of the first magnesium substrate 605. The BASF Oxsilan 9831 process can produce a magnesium substrate having a visual profile of the surface-finished magnesium substrate or the as-cast magnesium substrate, in contrast to a magnesium substrate that has been discolored by other pretreatment processes. The BASF Oxsilan 9831 process can result in a pretreated magnesium substrate (e.g., first magnesium substrate 605) that retains the metallic aesthetic of as-cast magnesium. The BASF Oxsilan 9831 process can reduce the roughness of the magnesium substrate. The first magnesium substrate 605 sanded with 40-grit paper can have a Ra of 0.9±0.2.

A second magnesium substrate 610 can include a magnesium substrate (e.g., AM60B magnesium substrate) that has undergone grinding (e.g., belt sanding, wire brushing, etc.) and the BASF Oxsilan 9831 process. The second magnesium substrate 610 can include a magnesium substrate that has undergone the BASF Oxsilan 9831 process. The BASF Oxsilan 9831 process can occur subsequent to the belt sanding or wire brushing process. The second magnesium substrate 610 can include, for example, the 40-grit ground magnesium substrate 405, the 60-grit ground magnesium substrate 410, the 80-grit ground magnesium substrate 415, or any other ground magnesium substrate. The top image of the second magnesium substrate 610 shows a first side of the second magnesium substrate 610. The bottom image of the second magnesium substrate 610 shows a second (e.g., opposite) side of the second magnesium substrate 610. The BASF Oxsilan 9831 process can produce a magnesium substrate having a visual profile of the surface-finished magnesium substrate or the as-cast magnesium substrate, in contrast to a magnesium substrate that has been discolored by other pretreatment processes. The BASF Oxsilan 9831 process can result in a pretreated magnesium substrate (e.g., second magnesium substrate 610) that retains the metallic aesthetic of as-cast magnesium. The BASF Oxsilan 9831 process can reduce the roughness of the magnesium substrate. The second magnesium substrate 610 ground with 40-grit paper can have a Ra of 2.75±0.6 measured perpendicular to the grinding. The second magnesium substrate 610 ground with 40-grit paper can have a Ra of 0.99±0.3 measured parallel to the grinding.

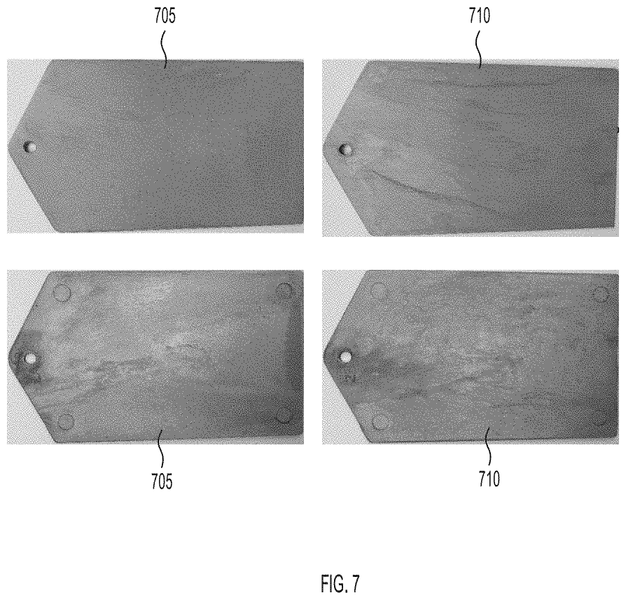

FIG. 7 illustrates the pretreated magnesium substrates of FIG. 6 that have undergone a powder coating process. A first powder-coated magnesium substrate 705 can include the first magnesium substrate 605 that has been power-coated. The first powder-coated magnesium substrate 705 can include a magnesium substrate that has undergone the powder coating process. The first powder-coated magnesium substrate 705 can include a magnesium substrate that has undergone the BASF Oxsilan 9831 process. The BASF Oxsilan 9831 process can be a pretreatment process applied before the powder-coating process. The first powder-coated magnesium substrate 705 can include a magnesium substrate that has undergone sanding. The first powder-coated magnesium substrate 705 can include the first magnesium substrate 605 after it has undergone a powder coating process. The powder coating process can include applying a powder coat (e.g., clear powder coat, low-gloss powder coat, etc.) onto the first magnesium substrate 605. The powder coating process can produce a magnesium substrate having a visual profile of the surface-finished magnesium substrate or the as-cast magnesium substrate, in contrast to a magnesium substrate that has been discolored by other pretreatment processes. The powder coating process can result in a powder-coated magnesium substrate (e.g., first powder-coated magnesium substrate 705) that retains the metallic aesthetic of as-cast magnesium. The surface roughness of the first powder-coated magnesium substrate 705 can be dominated by the roughness produced by the powder coating process. The first powder-coated magnesium substrate 705 sanded with 40-grit paper can have a Ra of 1.22±0.17.

A second powder-coated magnesium substrate 710 can include the second magnesium substrate 610 that has been power-coated. The second powder-coated magnesium substrate 710 can include the second magnesium substrate 610 after it has undergone a powder coating process. The second powder-coated magnesium substrate 710 can include a magnesium substrate that has undergone the BASF Oxsilan 9831 process. The BASF Oxsilan 9831 process can be a pretreatment process applied before the powder-coating process. The first powder-coated magnesium substrate 705 can include a magnesium substrate that has undergone grinding. The powder coating process can include applying a powder coat (e.g., clear powder coat, low-gloss powder coat, etc.) onto the second magnesium substrate 610. The powder coating process can produce a magnesium substrate having a visual profile of the surface-finished magnesium substrate or the as-cast magnesium substrate, in contrast to a magnesium substrate that has been discolored by other pretreatment processes. The powder coating process can result in a powder-coated magnesium substrate (e.g., second powder-coated magnesium substrate 710) that retains the metallic aesthetic of as-cast magnesium. The surface roughness of the second powder-coated magnesium substrate 710 can be dominated by the roughness produced by the powder coating process. The second powder-coated magnesium substrate 710 ground with 40-grit paper can have a Ra of 1.33±0.17 measured perpendicular to the grinding. The second powder-coated magnesium substrate 710 ground with 40-grit paper can have a Ra of 1.36±0.22 measured parallel to the grinding.

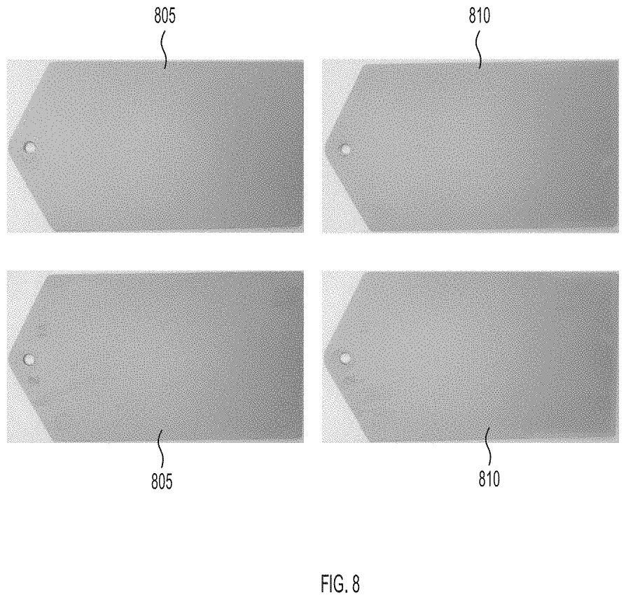

FIG. 8 illustrates sanded and ground magnesium substrates that have undergone a pretreatment process such as the Henkel MgC process (e.g., Henkel MgC treatment process). A third magnesium substrate 805 can include a magnesium substrate (e.g., AM60B magnesium substrate) that has undergone sanding (e.g., orbital sanding) and the Henkel MgC process. The third magnesium substrate 805 can include a magnesium substrate that has undergone the Henkel MgC process. The Henkel MgC process can occur subsequent to the orbital sanding process. The third magnesium substrate 805 can include, for example, the 40-grit sanded magnesium substrate 310, the 120-grit sanded magnesium substrate 315, the 180-grit sanded magnesium substrate 320, or any other sanded magnesium substrate. The top image of the third magnesium substrate 805 shows a first side of the third magnesium substrate 805. The bottom image of the third magnesium substrate 805 shows a second (e.g., opposite) side of the third magnesium substrate 805. The Henkel MgC process can produce a magnesium substrate having a visual profile of the surface-finished magnesium substrate or the as-cast magnesium substrate, in contrast to a magnesium substrate that has been discolored by other pretreatment processes. The Henkel MgC process can result in a pretreated magnesium substrate (e.g., third magnesium substrate 805) that retains the metallic aesthetic of as-cast magnesium. The Henkel MgC process can reduce the roughness of the magnesium substrate. The third magnesium substrate 805 sanded with 40-grit paper can have a Ra of 1.1±0.4.

A fourth magnesium substrate 810 can include a magnesium substrate (e.g., AM60B magnesium substrate) that has undergone grinding (e.g., belt sanding, wire brushing, etc.) and the Henkel MgC process. The fourth magnesium substrate 810 can include a magnesium substrate that has undergone the Henkel MgC process. The Henkel MgC process can occur subsequent to the belt sanding or wire brushing process. The fourth magnesium substrate 810 can include, for example, the 40-grit ground magnesium substrate 405, the 60-grit ground magnesium substrate 410, the 80-grit ground magnesium substrate 415, or any other ground magnesium substrate. The top image of the fourth magnesium substrate 810 shows a first side of the fourth magnesium substrate 810. The bottom image of the fourth magnesium substrate 810 shows a second (e.g., opposite) side of the fourth magnesium substrate 810. The Henkel MgC process can produce a magnesium substrate having a visual profile of the surface-finished magnesium substrate or the as-cast magnesium substrate, in contrast to a magnesium substrate that has been discolored by other pretreatment processes. The Henkel MgC process can result in a pretreated magnesium substrate (e.g., fourth magnesium substrate 810) that retains the metallic aesthetic of as-cast magnesium. The Henkel MgC process can reduce the roughness of the magnesium substrate. The fourth magnesium substrate 810 ground with 40-grit paper can have a Ra of 2.6±0.4 measured perpendicular to the grinding. The fourth magnesium substrate 810 ground with 40-grit paper can have a Ra of 0.55±0.1 measured parallel to the grinding.

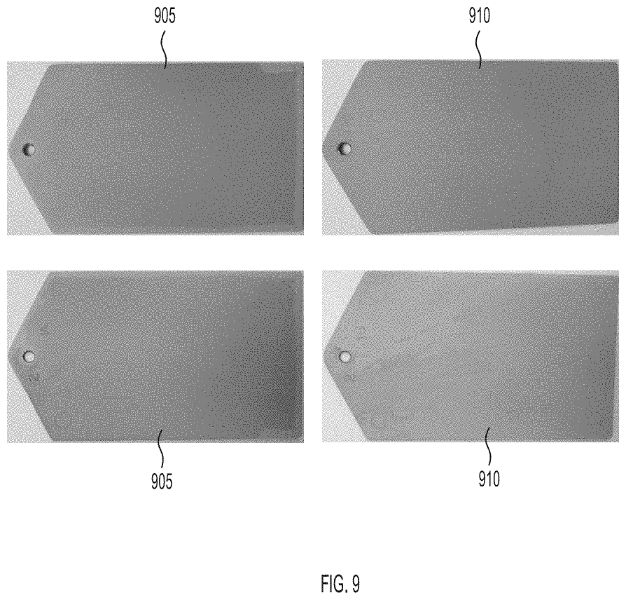

FIG. 9 illustrates the pretreated magnesium substrates of FIG. 8 that have undergone a powder coating process. A third powder-coated magnesium substrate 905 can include the third magnesium substrate 805 that has been power-coated. The third powder-coated magnesium substrate 905 can include the third magnesium substrate 805 after it has undergone a powder coating process. The third powder-coated magnesium substrate 905 can include a magnesium substrate that has undergone the Henkel MgC process. The MgC process can be a pretreatment process applied before the powder-coating process. The third powder-coated magnesium substrate 905 can include a magnesium substrate that has undergone sanding. The powder coating process can include applying a powder coat (e.g., clear powder coat, low-gloss powder coat, etc.) onto the third magnesium substrate 805. The powder coating process can produce a magnesium substrate having a visual profile of the surface-finished magnesium substrate or the as-cast magnesium substrate, in contrast to a magnesium substrate that has been discolored by other pretreatment processes. The powder coating process can result in a powder-coated magnesium substrate (e.g., third powder-coated magnesium substrate 905) that retains the metallic aesthetic of as-cast magnesium. The surface roughness of the third powder-coated magnesium substrate 905 can be dominated by the roughness produced by the powder coating process. The third powder-coated magnesium substrate 905 sanded with 40-grit paper can have a Ra of 1.27±0.15.

A fourth powder-coated magnesium substrate 910 can include the fourth magnesium substrate 810 that has been power-coated. The fourth powder-coated magnesium substrate 910 can include the fourth magnesium substrate 810 after it has undergone a powder coating process. The fourth powder-coated magnesium substrate 910 can include a magnesium substrate that has undergone the Henkel MgC process. The MgC process can be a pretreatment process applied before the powder-coating process. The fourth powder-coated magnesium substrate 910 can include a magnesium substrate that has undergone grinding. The powder coating process can include applying a powder coat (e.g., clear powder coat, low-gloss powder coat, etc.) onto the fourth magnesium substrate 810. The powder coating process can produce a magnesium substrate having a visual profile of the surface-finished magnesium substrate or the as-cast magnesium substrate, in contrast to a magnesium substrate that has been discolored by other pretreatment processes. The powder coating process can result in a powder-coated magnesium substrate (e.g., fourth powder-coated magnesium substrate 910) that retains the metallic aesthetic of as-cast magnesium. The surface roughness of the fourth powder-coated magnesium substrate 910 can be dominated by the roughness produced by the powder coating process. The fourth powder-coated magnesium substrate 910 ground with 40-grit paper can have a Ra of 1.3±0.2 measured perpendicular to the grinding. The fourth powder-coated magnesium substrate 910 ground with 40-grit paper can have a Ra of 1.27±0.2 measured parallel to the grinding.

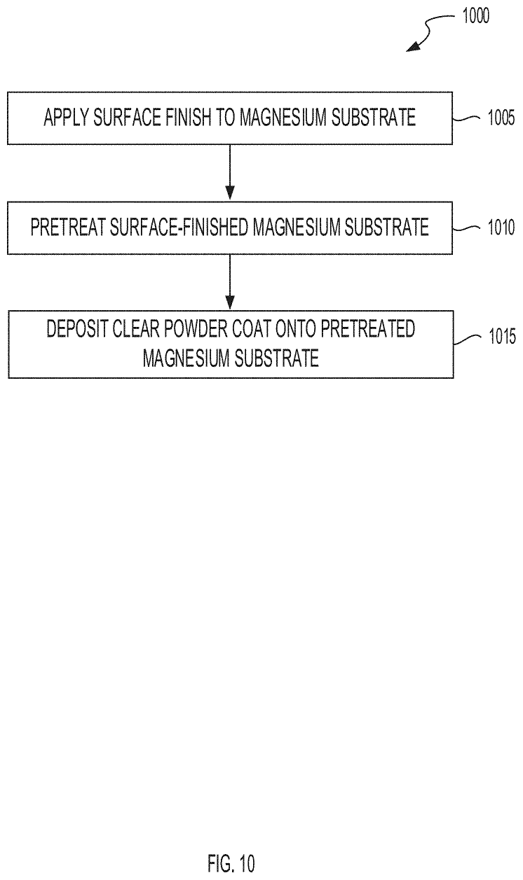

FIG. 10 illustrates a method 1000 of coating magnesium. In brief summary, the method 1000 includes applying a surface finish to a magnesium substrate in a step 1005, pretreating the surface-finished magnesium substrate in a step 1010, and depositing a clear powder coat onto the pretreated magnesium substrate in a step 1015.

Additional details of the processing method 1000 are now provided. In step 1005, a surface finish is applied to a magnesium substrate to obtain a surface-finished magnesium substrate having a visual profile that advantageously retains the visual appearance of the underlying magnesium substrate (e.g., raw magnesium). Any of a variety of alloys may be used to form the magnesium substrate, such as, but not limited to, magnesium alloy AM60B, magnesium alloy AM50A, or magnesium alloy AZ91D. During the surface finishing step, depending on the aesthetic desired, an orbital sanding, belt sanding, wire brushing, and/or laser etching process may be employed. As described above, each of these processes may be varied to obtain a desired surface finish appearance.

In step 1010, the surface-finished magnesium substrate undergoes a pretreating step. The pretreating step can include treating the surface-finished magnesium substrate with a BASF Oxsilan 9831 process to obtain a pretreated magnesium substrate (e.g., pretreated magnesium-containing substrate). The BASF Oxsilan 9831 process can include a multi-purpose liquid pretreatment. The BASF Oxsilan 9831 process does not discolor the surface-finished magnesium substrate. The BASF Oxsilan 9831 process can include alkaline cleaning of the magnesium substrates with a cleaner (e.g., TP10367) to removal oil, lubricant, debris or any contamination, etc. The BASF Oxsilan 9831 process can include rinsing the magnesium substrate twice with water (e.g., city water, tap water, etc.). The BASF Oxsilan 9831 process can include deoxidizing the magnesium substrate with Gardacid P4462/1 to remove the oxide layer on the magnesium substrate. The BASF Oxsilan 9831 process can include can include rising the magnesium substrate twice with water (e.g., deionized water, reverse osmosis water, etc.). The BASF Oxsilan 9831 process can include applying Oxsilan 9831 (e.g., silane-based, multi-purpose, liquid pretreatment) to the magnesium substrate. The BASF Oxsilan 9831 process can include rising the magnesium substrate twice with water (e.g., deionized water, reverse osmosis water, etc.) after applying Oxsilan 9831 to the magnesium substrate. The BASF Oxsilan 9831 process can include degassing and drying the magnesium substrate.

According to another exemplary embodiment, the step 1010 may instead employ a Henkel MgC process to obtain a pretreated magnesium substrate (e.g., pretreated magnesium-containing substrate) that results in a magnesia surface layer that is 2 μm to 4 μm thick over the magnesium substrate. The Henkel MgC process can include a plasma electrolytic ceramic deposition process. The Henkel MgC process can give the surface-finished magnesium substrate a white appearance. The visual appearance of the pretreated magnesium substrate can be the same as the visual appearance of the surface-finished magnesium substrate, raw magnesium, or as-cast magnesium substrate. The Henkel MgC process can include alkaline cleaning of the magnesium substrate with a cleaner (e.g., Bonderite C-IC6849). The Henkel MgC process can include rinsing the magnesium substrate twice with water (e.g., city water, tap water, etc.). The Henkel MgC process can include deoxidizing the magnesium substrate with Bonderite C-IC 8242 to remove the oxide layer on the magnesium substrate. The Henkel MgC process can include rising the magnesium substrate twice with water (e.g., deionized water, reverse osmosis water, etc.). The Henkel MgC process can include applying MgC to the magnesium substrate. The Henkel MgC process can include rising the magnesium substrate twice with water (e.g., deionized water, reverse osmosis water, etc.) after applying MgC to the magnesium substrate. The Henkel MgC process can include drying the magnesium substrate.

In a step 1015, a clear powder coat is deposited onto the pretreated magnesium substrate to obtain a powder-coated magnesium substrate (e.g., powder-coated magnesium-containing substrate). The powder-coated magnesium substrate can retain the visual profile of the surface-finished magnesium substrate or the as-cast magnesium substrate. The clear powder coat can include a low-gloss powder coat. The clear powder coat can prevent oxidation and thus provide a level of corrosion resistance, and may also provide a level of UV-resistance. The low-gloss powder coat can provide a clear finish with minimal pinholes or pores. For example, the density of pinholes and/or holes can be such that the powder-coated magnesium substrate is not susceptible to corrosion. The visual appearance of the powder-coated magnesium substrate can be the same as the visual appearance of the surface-finished magnesium substrate, raw magnesium, or as-cast magnesium substrate.

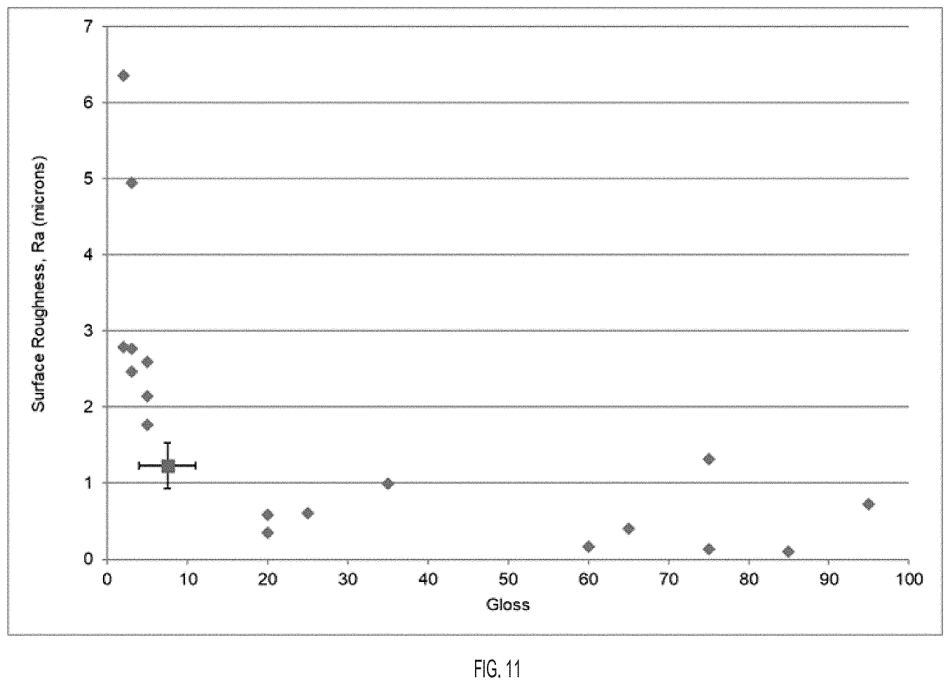

FIG. 11 illustrates a plot of surface roughness vs. powder coat gloss level of magnesium substrates. The surface roughness, Ra, can be measured in microns. A gloss level between 4 and 12 can result in a magnesium substrate that has a powder coat that is not visually obvious on the surface due to a high gloss or high texture. A surface roughness between 0.93 to 1.53 microns can result in a magnesium substrate that has a surface roughness that is similar to as-cast magnesium.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth). Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 layers refers to groups having 1, 2, or 3 layers. Similarly, a group having 1-5 layers refers to groups having 1, 2, 3, 4, or 5 layers, and so forth.

The drawings shall be interpreted as illustrating one or more embodiments that are drawn to scale and/or one or more embodiments that are not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that can be formed by such values.

Unless explicitly indicated otherwise, all specified embodiments, features, and terms intend to include both the recited embodiment, feature, or term and biological equivalents thereof.

All patents, patent applications, provisional applications, and publications referred to or cited herein are incorporated by reference in their entirety, including all figures and tables, to the extent they are not inconsistent with the explicit teachings of this specification.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A method of treating a substrate that comprises magnesium and aluminum, the method comprising:
applying a surface finish treatment to a substrate that comprises magnesium and aluminum so as to obtain a surface-finished substrate having a visual profile, the substrate comprising greater than 90 wt % magnesium;
pretreating the surface-finished substrate comprising magnesium and aluminum by:
cleaning the surface-finished substrate comprising magnesium and aluminum with an alkaline cleaner;
deoxidizing the surface-finished substrate comprising magnesium and aluminum; and
applying a silane-based pretreatment to the surface-finished substrate comprising magnesium and aluminum; and
depositing a clear powder coat onto the pretreated substrate to obtain a powder-coated substrate, wherein the clear powder coat is a UV-resistant powder coat;
wherein the powder-coated magnesium substrate retains the visual profile of the surface-finished substrate.

2. The method of claim 1, wherein the substrate comprises magnesium alloy AM60B.

3. The method of claim 1, wherein the substrate comprises magnesium alloy AM50A.

4. The method of claim 1, wherein the substrate comprises magnesium alloy AZ91D.

5. The method of claim 1, wherein the surface finish comprises orbital sanding.

6. The method of claim 1, wherein the surface finish comprises belt sanding.

7. The method of claim 1, wherein the surface finish comprises grinding.

8. The method of claim 1, wherein the surface finish comprises laser etching.

9. The method of claim 1, wherein the clear powder coat comprises a low-gloss powder coat.

10. The method of claim 1, wherein the clear powder coat has a thickness of 50-200 μm.

11. A method of coating a magnesium-containing substrate, the method comprising:
applying a surface finish to a magnesium-containing substrate to obtain a surface-finished magnesium substrate having a visual profile;
pretreating the magnesium substrate with a Henkel MgC process to obtain a pretreated magnesium-containing substrate; and
depositing a clear powder coat onto the pretreated magnesium-containing substrate to obtain a powder-coated magnesium-containing substrate;
wherein the powder-coated magnesium-containing substrate retains the visual profile of the surface-finished magnesium-containing substrate.

12. The method of claim 11, wherein the magnesium-containing substrate comprises magnesium alloy AM60B.

13. The method of claim 11, wherein the magnesium-containing substrate comprises magnesium alloy AM50A.

14. The method of claim 11, wherein the magnesium-containing substrate comprises magnesium alloy AZ91D.

15. The method of claim 11, wherein the surface finish comprises orbital sanding.

16. The method of claim 11, wherein the surface finish comprises belt sanding.

17. The method of claim 11, wherein the surface finish comprises grinding.

18. The method of claim 11, wherein the surface finish comprises laser etching.

19. The method of claim 11, wherein the clear powder coat comprises a low-gloss powder coat.

20. The method of claim 11, wherein the clear powder coat has a thickness of 50-200 μm.
